(19) United States
(12) Patent Application Publication
(10) Pub. No.: US 2012/0027609 A1
(43) Pub. Date: Feb. 2, 2012

(54) WIND TURBINE ROTOR BLADE WITH PRECURED FIBER RODS AND METHOD FOR PRODUCING THE SAME

(76) Inventors: Prasad Ogde, Bangalore (IN); Afroz Akhtar, Bangalore (IN); Jacob Johannes Nies, Zwolle (NL)

(21) Appl. No.: 13/109,358

(22) Filed: May 17, 2011

(51) Int. Cl. F01D 5/14; B23P 15/02

(52) U.S. Cl. 416/226; 29/889.71

(57) ABSTRACT

A wind turbine rotor blade comprises a rotor blade body, including a root portion, a leading edge, a trailing edge, and at least one spar cap; a plurality of parallel, elongated elements of a pre-cured composite material, which comprise fibers and a resin, and a resin connecting the plurality of elements. Further, a method for producing a rotor blade is provided.

### BACKGROUND OF THE INVENTION

The subject matter described herein relates generally to methods and systems for wind turbine rotor blades, and more particularly, to methods and systems for the structural reinforcement of wind turbine rotor blades.

At least some known wind turbines include a tower and a nacelle mounted on the tower. A rotor is rotatably mounted to the nacelle and is coupled to a generator by a shaft. A plurality of blades extend from the rotor. The blades are oriented such that wind passing over the blades turns the rotor and rotates the shaft, thereby driving the generator to generate electricity.

Typically, the body of a wind turbine rotor blade includes a laminate of a resin and fiber material. Also structural elements like spar caps and the root portions of the rotor blade are fabricated in this manner. Typically, a spar cap is produced by inserting layers of glass fiber in a mold, and by subsequently inserting a resin in order to connect the layers after curing. Also, carbon fiber materials have gained importance in recent years. The spar caps significantly add to the strength and stability of the wind turbine rotor blade. In comparison to other parts of the blade, they are relatively heavy and typically contribute significantly to the weight of the rotor blade. Also the root portion contributes significantly to the overall strength of the blade, as it has to withstand high bending forces during operation.

Wind turbines, and consequently also the rotor blades, have grown significantly in size in recent years, requiring increasing stability of structural elements like blade roots and spar caps.

In view of the above, it is desired to have a wind turbine rotor blade which delivers improved stability in comparison to conventional designs.

### BRIEF DESCRIPTION OF THE INVENTION

In one aspect, a wind turbine rotor blade is provided. The rotor blade includes a rotor blade body, including a root portion, a leading edge, a trailing edge, and at least one spar cap; a plurality of parallel, elongated elements of a pre-cured composite material, which include fibers and a resin; and a resin connecting the plurality of elements.

In another aspect, a wind turbine is provided. The wind turbine includes a tower, a nacelle situated on the tower, and a rotor rotatably attached to the nacelle, having at least one rotor blade. The at least one rotor blade includes a rotor blade body, including a root portion, a leading edge, a trailing edge, and at least one spar cap; and a plurality of parallel, elongated elements of a pre-cured composite material, which include fibers and a resin; and a resin connecting the plurality of elements.

In a further aspect, a method for producing a wind turbine rotor blade is provided. The method includes providing an elongated element of a pre-cured composite material; depositing the element in a mold; iterating the depositing so that at least one layer of pre-cured elements is formed; and injecting a resin into the layer formed by the elongated pre-cured elements.

Further aspects, advantages and features of the present invention are apparent from the dependent claims, the description and the accompanying drawings.

### BRIEF DESCRIPTION OF THE DRAWINGS

A full and enabling disclosure including the best mode thereof, to one of ordinary skill in the art, is set forth more particularly in the remainder of the specification, including reference to the accompanying figures wherein:

FIG. 1 is a perspective view of an exemplary wind turbine.

FIG. 2 is an enlarged sectional view of a portion of the wind turbine shown in FIG. 1.

FIG. 3 is a cross sectional view of a wind turbine rotor blade according to embodiments.

FIG. 4 is an enlarged sectional view of a portion of the wind turbine rotor blade of FIG. 4.

FIG. 5 is an enlarged sectional view of a portion of a wind turbine rotor blade according to further embodiments.

FIG. 6 is a cross sectional view of a wind turbine rotor blade according to embodiments.

FIG. 7 is a cross sectional side view on a spar cap of a wind turbine rotor blade according to embodiments.

FIG. 8 shows five partial cross-sectional views at different positions of a wind turbine rotor blade spar cap according to embodiments.

FIG. 9 shows a top view of the manufacturing of a wind turbine rotor blade spar cap according to embodiments.

FIG. 10 shows a side view of the manufacturing of a wind turbine rotor blade spar cap according to embodiments.

FIG. 11 shows a further side view of the manufacturing of a wind turbine rotor blade spar cap according to embodiments.

FIG. 12 shows a top view on a layer of elements of a wind turbine rotor blade spar cap according to embodiments.

FIG. 13 shows a side view of the manufacturing of a wind turbine rotor blade spar cap according to embodiments.

FIG. 14 shows a further side view of the manufacturing of a wind turbine rotor blade spar cap according to embodiments.

FIGS. 15 to 17 show cross-sectional views of a part of a wind turbine rotor blade according to embodiments.

FIG. 18 shows a cross-sectional view of a wind turbine rotor blade according to embodiments.

FIG. 19 shows a partial cross-sectional view of a wind turbine rotor blade according to embodiments.

FIG. 20 shows a cross sectional view and a detailed cross sectional view through the root portion of a rotor blade according to embodiments.

FIG. 21 shows a detailed cross sectional view through a root portion of a rotor blade according to embodiments.

FIG. 22 shows a schematical view on a process of manufacturing a rotor blade according to embodiments.

FIG. 23 shows a further schematical view of a process of producing a rotor blade according to embodiments.

FIGS. 24 to 26 show methods of pre-treating elements according to embodiments.

FIG. 27 schematically shows a method for producing a wind turbine rotor blade according to embodiments.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

The embodiments described herein include a wind turbine system that has at least one rotor blade including pre-cured elements.

As used herein, the term “spar cap” is intended to be representative of an elongated structure which increases the strength of a wind turbine rotor blade. As used herein, the terms “injected” and “vacuum infused” are both intended to be representative for a method of inserting a resin into a layer of fibrous material. In technical applications, injection and vacuum infusion describe different methods. However, in the present disclosure, the terms are used interchangeably, as they have the common aim of providing a resin into a layer of fibrous material. Which method is actually chosen for which specific purpose is a matter of choice of the person skilled in the art, on which he will decide on the basis of his standard knowledge. As used herein, the term “blade” is intended to be representative of any device that provides a reactive force when in motion relative to a surrounding fluid. As used herein, the term “wind turbine” is intended to be representative of any device that generates rotational energy from wind energy, and more specifically, converts kinetic energy of wind into mechanical energy. As used herein, the term “wind generator” is intended to be representative of any wind turbine that generates electrical power from rotational energy generated from wind energy, and more specifically, converts mechanical energy converted from kinetic energy of wind to electrical power.

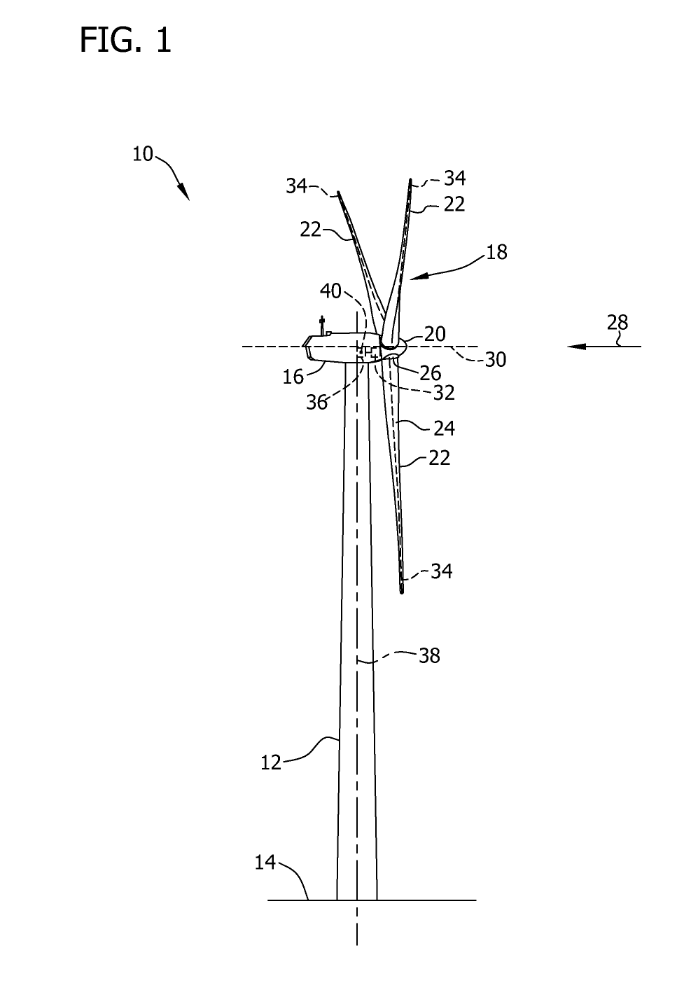

FIG. 1 is a perspective view of an exemplary wind turbine 10. In the exemplary embodiment, wind turbine 10 is a horizontal-axis wind turbine. Alternatively, wind turbine 10 may be a vertical-axis wind turbine. In the exemplary embodiment, wind turbine 10 includes a tower 12 that extends from a support system 14, a nacelle 16 mounted on tower 12, and a rotor 18 that is coupled to nacelle 16. Rotor 18 includes a rotatable hub 20 and at least one rotor blade 22 coupled to and extending outward from hub 20. In the exemplary embodiment, rotor 18 has three rotor blades 22. In an alternative embodiment, rotor 18 includes more or less than three rotor blades 22. In the exemplary embodiment, tower 12 is fabricated from tubular steel to define a cavity (not shown in FIG. 1) between support system 14 and nacelle 16. In an alternative embodiment, tower 12 is any suitable type of tower having any suitable height.

Rotor blades 22 are spaced about hub 20 to facilitate rotating rotor 18 to enable kinetic energy to be transferred from the wind into usable mechanical energy, and subsequently, electrical energy. Rotor blades 22 are mated to hub 20 by coupling a blade root portion 24 to hub 20 at a plurality of load transfer regions 26. Load transfer regions 26 have a hub load transfer region and a blade load transfer region (both not shown in FIG. 1). Loads induced to rotor blades 22 are transferred to hub 20 via load transfer regions 26.

In one embodiment, rotor blades 22 have a length ranging from about 15 meters (m) to about 91 m. Alternatively, rotor blades 22 may have any suitable length that enables wind turbine 10 to function as described herein. For example, other non-limiting examples of blade lengths include 10 m or less, 20 m, 37 m, or a length that is greater than 91 m. As wind strikes rotor blades 22 from a direction 28, rotor 18 is rotated about an axis of rotation 30. As rotor blades 22 are rotated and subjected to centrifugal forces as well as to lift and drag forces leading to internal moments, rotor blades 22 are also subjected to various forces and moments. As such, rotor blades 22 may deflect and/or rotate from a neutral, or non-deflected, position to a deflected position.

Moreover, a pitch angle or blade pitch of rotor blades 22, i.e., an angle that determines a perspective of rotor blades 22 with respect to direction 28 of the wind, may be changed by a pitch adjustment system 32 to control the load and power generated by wind turbine 10 by adjusting an angular position of at least one rotor blade 22 relative to wind vectors. Pitch axes 34 for rotor blades 22 are shown. During operation of wind turbine 10, pitch adjustment system 32 may change a blade pitch of rotor blades 22 such that rotor blades 22 are moved to a feathered position, such that the perspective of at least one rotor blade 22 relative to wind vectors provides a minimal surface area of rotor blade 22 to be oriented towards the wind vectors, which facilitates reducing a rotational speed of rotor 18 and/or facilitates a stall of rotor 18.

In the exemplary embodiment, a blade pitch of each rotor blade 22 is controlled individually by a control system 36. Alternatively, the blade pitch for all rotor blades 22 may be controlled simultaneously by control system 36. Further, in the exemplary embodiment, as direction 28 changes, a yaw direction of nacelle 16 may be controlled about a yaw axis 38 to position rotor blades 22 with respect to direction 28.

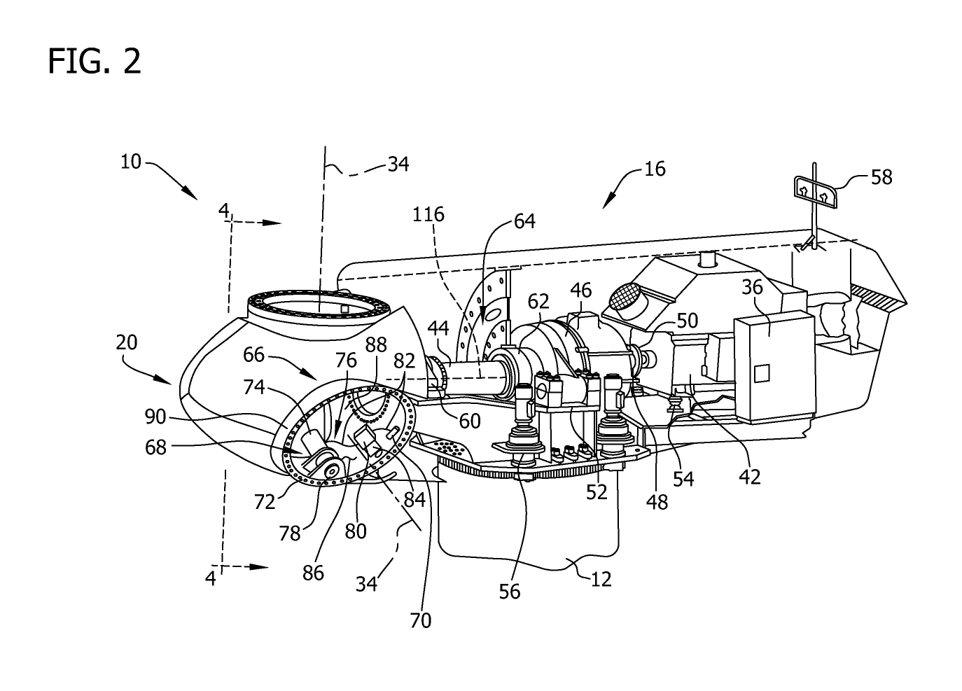

FIG. 2 is an enlarged sectional view of a portion of wind turbine 10. In the exemplary embodiment, wind turbine 10 includes nacelle 16 and hub 20 that is rotatably coupled to nacelle 16. More specifically, hub 20 is rotatably coupled to an electric generator 42 positioned within nacelle 16 by rotor shaft 44 (sometimes referred to as either a main shaft or a low speed shaft), a gearbox 46, a high speed shaft 48, and a coupling 50. In the exemplary embodiment, rotor shaft 44 is disposed coaxial to longitudinal axis 116. Rotation of rotor shaft 44 rotatably drives gearbox 46 that subsequently drives high speed shaft 48. High speed shaft 48 rotatably drives generator 42 with coupling 50 and rotation of high speed shaft 48 facilitates production of electrical power by generator 42. Gearbox 46 and generator 42 are supported by a support 52 and a support 54. In the exemplary embodiment, gearbox 46 utilizes a dual path geometry to drive high speed shaft 48. Alternatively, rotor shaft 44 is coupled directly to generator 42 with coupling 50.

Nacelle 16 also includes a yaw drive mechanism 56 that may be used to rotate nacelle 16 and hub 20 on yaw axis 38 (shown in FIG. 1) to control the perspective of rotor blades 22, respectively the rotor, with respect to direction 28 of the wind. Nacelle 16 also includes at least one meteorological mast 58 that includes a wind vane and anemometer (neither shown in FIG. 2). Mast 58 provides information to control system 36 that may include wind direction and/or wind speed. In the exemplary embodiment, nacelle 16 also includes a main forward support bearing 60 and a main aft support bearing 62.

Forward support bearing 60 and aft support bearing 62 facilitate radial support and alignment of rotor shaft 44. Forward support bearing 60 is coupled to rotor shaft 44 near hub 20. Aft support bearing 62 is positioned on rotor shaft 44 near gearbox 46 and/or generator 42. Alternatively, nacelle 16 includes any number of support bearings that enable wind turbine 10 to function as disclosed herein. Rotor shaft 44, generator 42, gearbox 46, high speed shaft 48, coupling 50, and any associated fastening, support, and/or securing device including, but not limited to, support 52 and/or support 54, and forward support bearing 60 and aft support bearing 62, are sometimes referred to as a drive train 64.

In the exemplary embodiment, hub 20 includes a pitch assembly 66. Pitch assembly 66 includes one or more pitch drive systems 68 and at least one sensor 70. Each pitch drive system 68 is coupled to a respective rotor blade 22 (shown in FIG. 1) for modulating the blade pitch of associated rotor blade 22 along pitch axis 34. Only one of three pitch drive systems 68 is shown in FIG. 2.

In the exemplary embodiment, pitch assembly 66 includes at least one pitch bearing 72 coupled to hub 20 and to respective rotor blade 22 (shown in FIG. 1) for rotating respective rotor blade 22 about pitch axis 34. Pitch drive system 68 includes a pitch drive motor 74, pitch drive gearbox 76, and pitch drive pinion 78. Pitch drive motor 74 is coupled to pitch drive gearbox 76 such that pitch drive motor 74 imparts mechanical force to pitch drive gearbox 76. Pitch drive gearbox 76 is coupled to pitch drive pinion 78 such that pitch drive pinion 78 is rotated by pitch drive gearbox 76. Pitch bearing 72 is coupled to pitch drive pinion 78 such that the rotation of pitch drive pinion 78 causes rotation of pitch bearing 72. More specifically, in the exemplary embodiment, pitch drive pinion 78 is coupled to pitch bearing 72 such that rotation of pitch drive gearbox 76 rotates pitch bearing 72 and rotor blade 22 about pitch axis 34 to change the blade pitch of blade 22.

Pitch drive system 68 is coupled to control system 36 for adjusting the blade pitch of rotor blade 22 upon receipt of one or more signals from control system 36. In the exemplary embodiment, pitch drive motor 74 is any suitable motor driven by electrical power and/or a hydraulic system that enables pitch assembly 66 to function as described herein. Alternatively, pitch assembly 66 may include any suitable structure, configuration, arrangement, and/or components such as, but not limited to, hydraulic cylinders, springs, and/or servo-mechanisms. Moreover, pitch assembly 66 may be driven by any suitable means such as, but not limited to, hydraulic fluid, and/or mechanical power, such as, but not limited to, induced spring forces and/or electromagnetic forces. In certain embodiments, pitch drive motor 74 is driven by energy extracted from a rotational inertia of hub 20 and/or a stored energy source (not shown) that supplies energy to components of wind turbine 10.

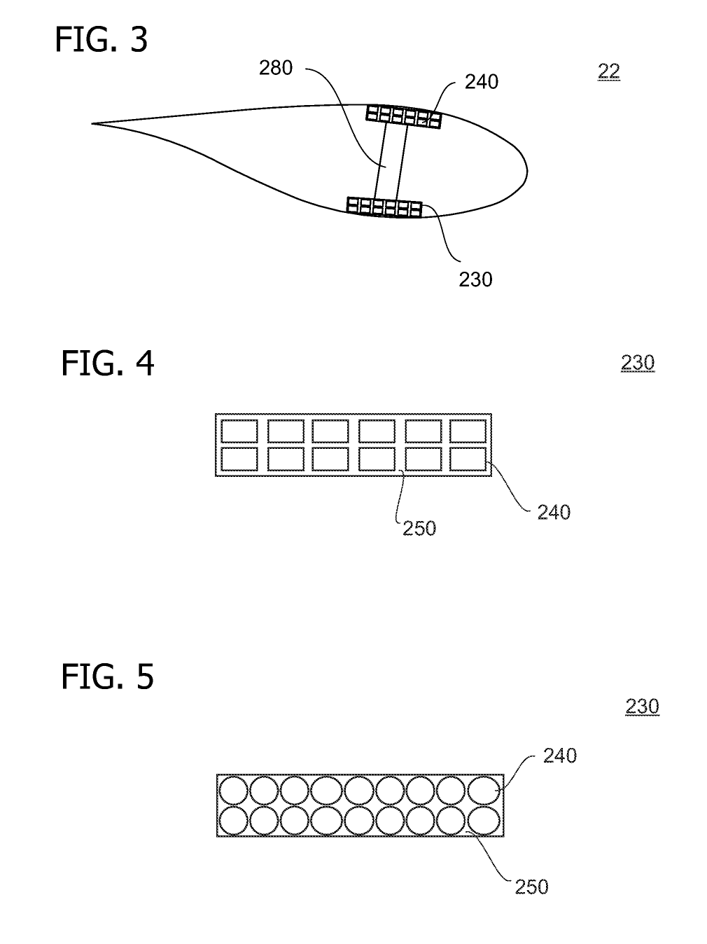

FIG. 3 schematically shows a cross-sectional view of a wind turbine rotor blade 22 according to embodiments. Two spar caps 230 each include a plurality of parallel, elongated elements 240. The elements include a pre-cured composite material including fibers and a resin, wherein the elements are bond together by a resin. The spar caps 230 protrude from a root portion of the blade in a direction of the longitudinal axis of the blade to a tip portion of the blade. They are typically connected by a shear web 280 (only schematically shown).

FIG. 4 shows a more detailed cross-sectional view of a spar cap 230 with elongated elements 240 according to embodiments. The elements 240 are connected via a resin 250, which fills gaps between the elements. The elements 240 themselves may have a rectangular cross section as shown in FIG. 3 and FIG. 4, or may have a circular cross section as shown in FIG. 5. In embodiments, also other cross sections are possible, for instance, a polygon, a rectangle, or an ellipse.

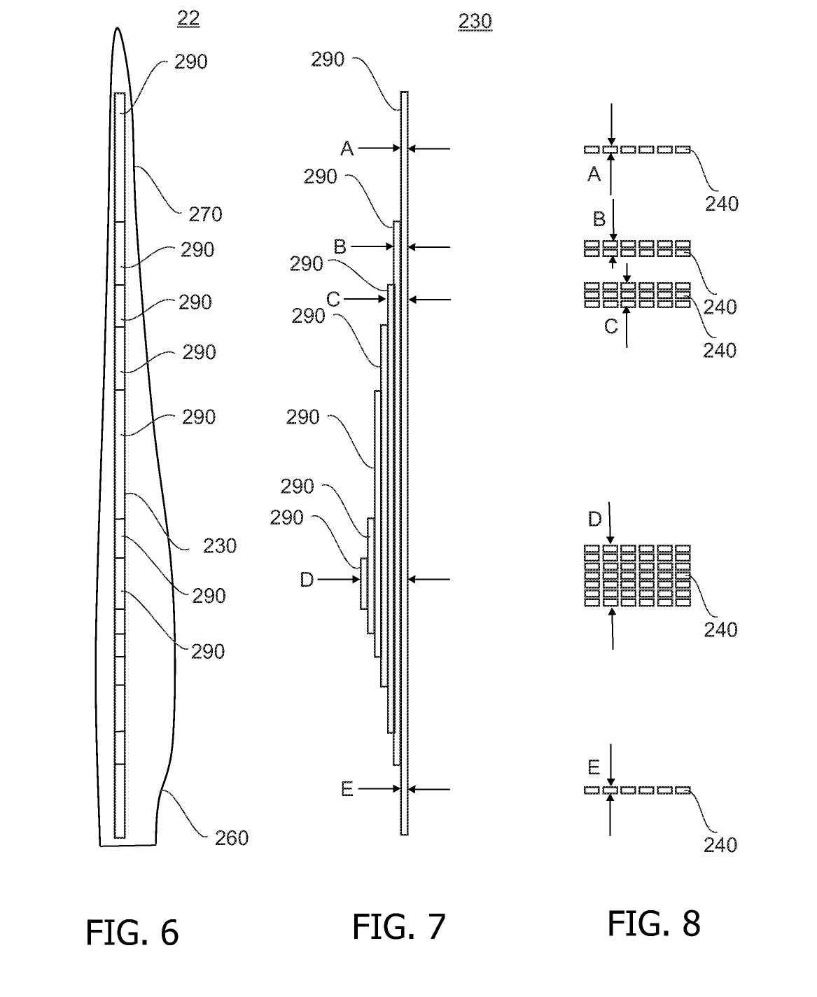

FIG. 6 shows a top view of the wind turbine rotor blade 22 according to the embodiments of FIGS. 3 to 5, with a cross-sectional view on the outline of a spar cap 230. The spar cap 230 includes various layers 290 and protrudes from a root section 260 of the rotor blade 22 to a tip portion 270.

FIG. 7 shows a side view of a spar cap 230 as of FIG. 6. Therein, the proportions are not depicted on scale for illustrational purposes. The spar cap includes a plurality of layers 290. Each layer 290 includes a number of parallel elongated elements 240. The elements 240 within a layer are bond together by a resin (not shown). The layers 290 are bond to their respective neighboring layers by a resin. The different layers 290 typically have different lengths in a direction of the longitudinal axis of the rotor blade 22. Accordingly, spar cap 230 has different thickness values along its length, resulting from the varying number of layers contributing thereto. This accounts, amongst other factors, for varying bending and torsional moments acting on the rotor blade 22 at different positions along its length. It is noted that the different layers 290 shown in FIG. 7 are visible in FIG. 6, where the edges of layers 290 are visible. Further, the elements 240 of the layers 290, as shown in FIG. 8, are not depicted in FIG. 6 for illustrational purposes.

FIG. 8 shows a number of cross-sectional views of the spar cap 230 at different positions along its length, which are depicted by letters A to E in FIG. 7. In the exemplary embodiment, at position A in the tip portion 270, the spar cap 230 includes one layer 290, which includes six parallel elements 240 having a rectangular cross section each. At position B, the spar cap has two layers, at position C three layers, at position D it has the maximum of seven layers 290 with six elements 240 each. At position D, the spar cap has its maximum thickness. As depicted in FIG. 8, the thickness of the spar cap decreases from there in a direction to the root portion 260 of the blade. At the root portion 260 (see FIG. 6), the spar cap exhibits a thickness corresponding to one layer 290, such as in the tip portion 270. The number of consecutive layers at different positions of the rotor blade, as well as the thickness of the layers itself, of course strongly depend on the strength and stiffness of the rotor blade as well as on the thickness and stiffness of the procured elements. Hence, these parameters may vary significantly from those in the exemplary embodiment as shown in FIG. 8.

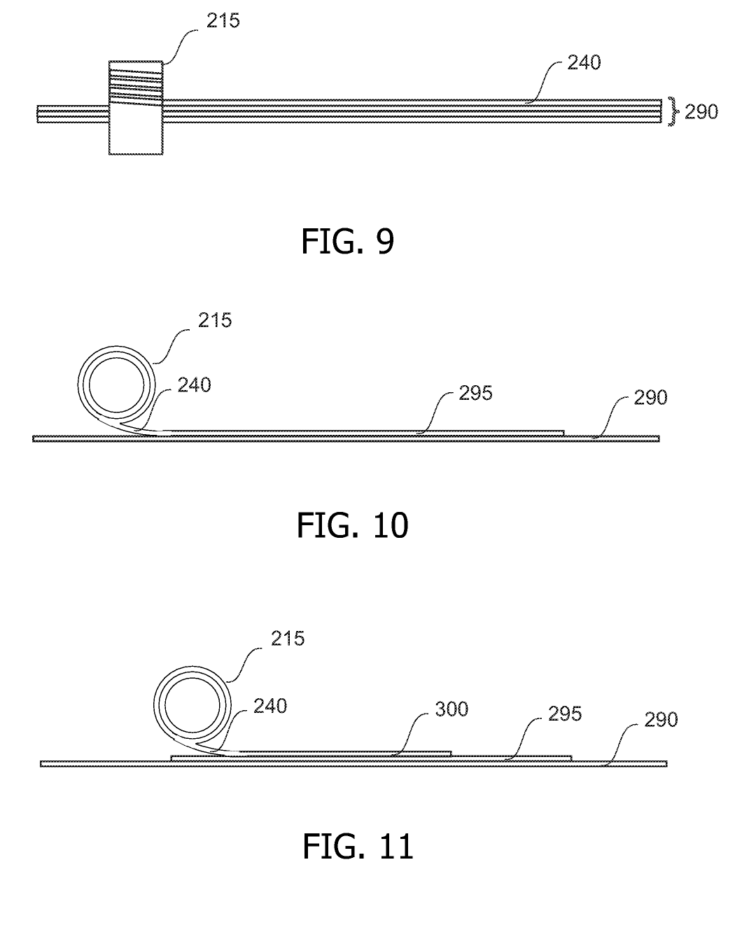

FIGS. 9 to 11 depict phases of an exemplary production process of a spar cap 230 according to embodiments. FIG. 9 shows a spool 215, on which the pre-cured material forming elements 240 is provided. The material includes fibers and a cured resin and is typically previously produced in a pultrusion process. Suitable fiber materials include carbon fiber, glass fiber, combinations thereof, or any other high strength fibrous material, which also pertains to any other embodiments described herein. After being rolled on spool 215, it is transported to the production facility of rotor blade 22. Starting from one end of the spar cap 230 to be formed, a line of the pre-cured material is unrolled from the spool and laid into a mold having the shape of the spar cap 230 to be formed. After the length needed for the first element 240 is unrolled, the pre-cured material is cut, and the process is repeated with a subsequent line of pre-cured material which is laid parallel to the first element 240. In FIG. 9, this process has been repeated three times, and the fourth element 240 is about to be completed. The numbers of elements used herein are merely by way of non-limiting examples and may differ in practical use. When a layer 290 of elongated elements 240 is completed, that is, when all parallel elements 240 of a layer 290 are positioned, the production of a further layer 295 on top of the first layer 290 is started. This is depicted in FIG. 10. FIG. 11 shows how an element 240 of a third layer 300 is positioned on layer 295.

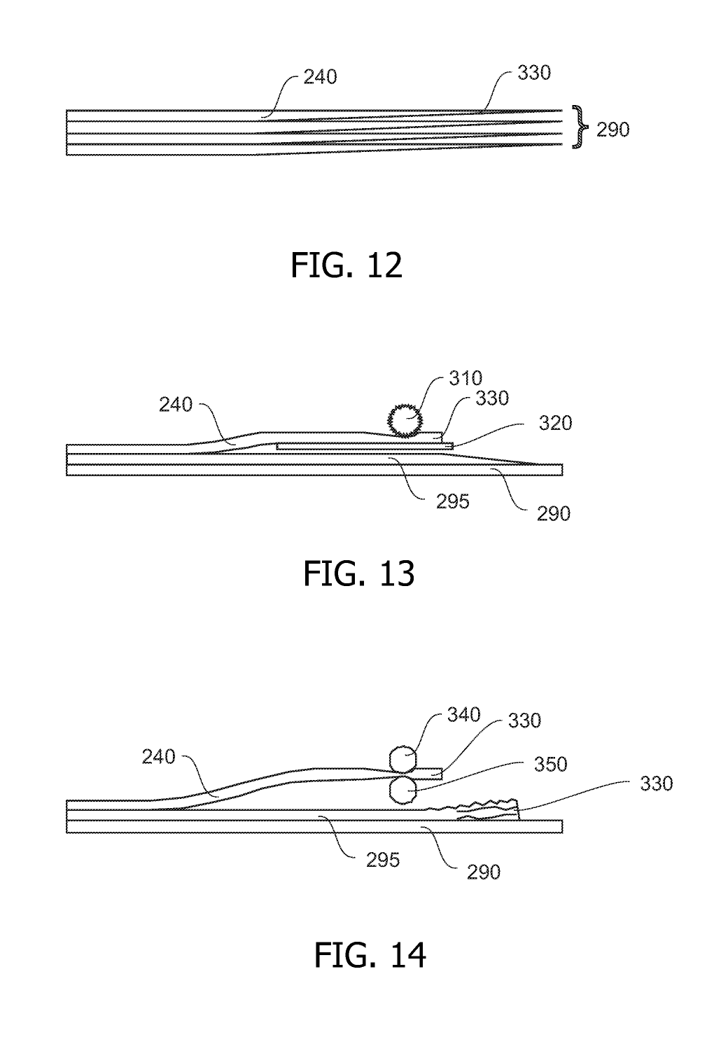

FIG. 12 shows an end portion of a layer 290 according to embodiments. Therein, the end portions 330 of the single elongated elements 240 are tapered. This feature provides for a smooth force progression along the spar cap 230 including a plurality of layers 230. If the end portions of the elements 240 would exhibit a sharp edge, the force progression of a force on spar cap 230, which is due to a bending moment, would exhibit a rapid incline respectively decline at the position where a layer ends. The end portions of the elements 330 may be milled to obtain the tapered end, just before positioning the element in the mold, respectively on the previous layer. The milling process is schematically shown in FIG. 13, with a milling tool 310 and a tool plate 320, through which end portion 330 is supported.

FIG. 14 schematically shows an end portion of a spar cap 230 according to a further embodiment. Therein, the end portion 330 of element 240 is squeezed between rollers 340, 350 in order to partially destroy the structure of the pre-cured fiber-resin material of the element 240. An element 295 which has been treated accordingly and exhibits an end portion 330 with a broken structure is schematically shown. The broken structure of the end portion of the fiber-resin-compound, respectively of all ends of the elements of a layer, lowers the ability of this portion of the element to transmit force between the end of the layer and the adjacent layer, in FIG. 14 layer 290, which serves the same purpose as the tapering of the end portions in the embodiment of FIG. 13.

The end portions 330 of the elongated elements 240 shown in FIGS. 13 and 14 exhibit a cross sectional shape different from that of other portions of the element, due to the described treatments.

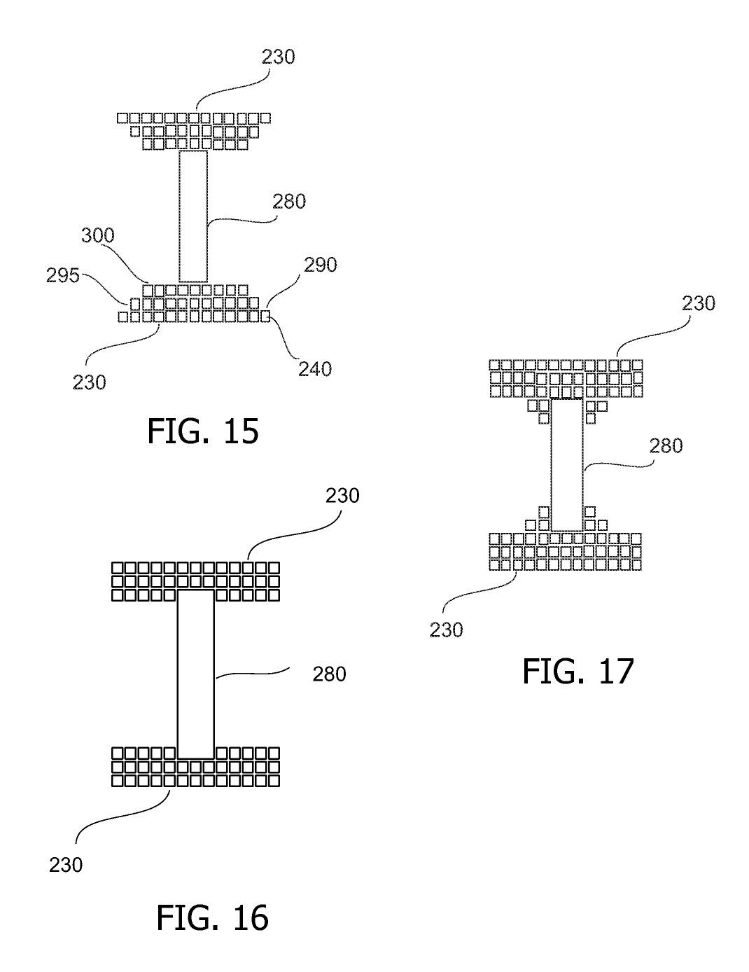

FIG. 15 shows a cross-sectional view of an embodiment, wherein two spar caps 230 are connected by a shear web 280. Therein, it is shown how a tapered spar cap is formed by layers 290 of elements 240, wherein the layers include different numbers of elements each. In the embodiment, the outermost layers 290 of spar caps 230 includes 13 elements 240, the second layer 295 includes 11 elements, and the innermost layer includes 9 elements.

FIG. 16 shows a further embodiment, wherein the spar caps 230 are formed to exhibit a kind of channel for taking up the shear web 280, which provides for improved stability.

FIG. 17 shows a further embodiment, wherein the spar caps exhibit both a tapered shape as in FIG. 15 and a channel as in the embodiment of FIG. 16.

The embodiments shown in FIGS. 15 to 17 may be produced by a method as described hereinbefore.

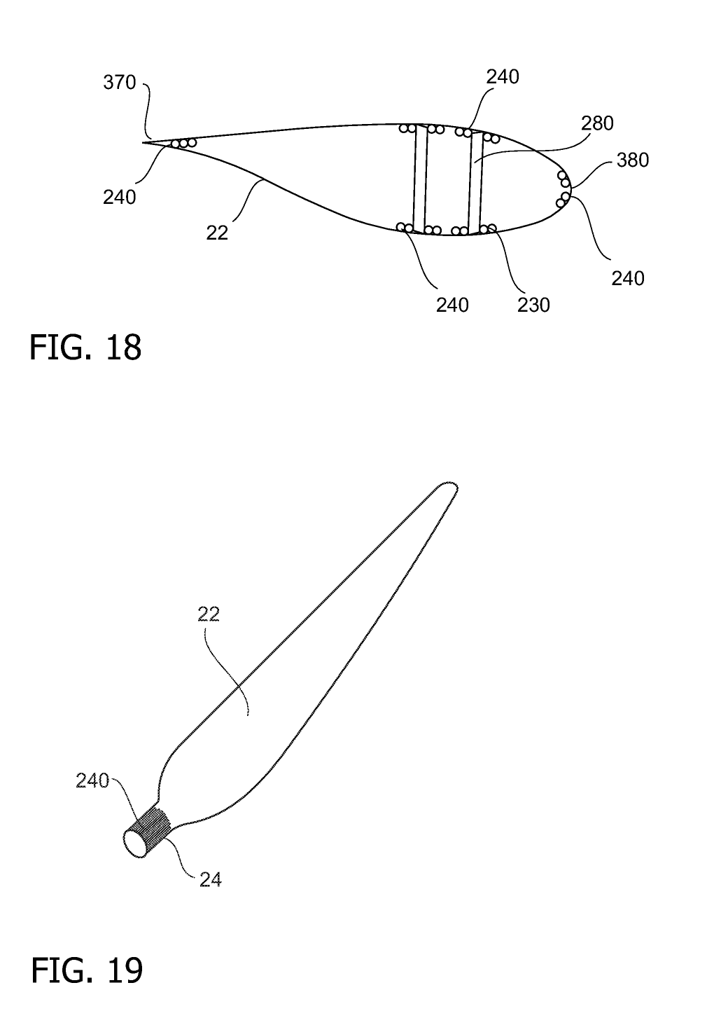

FIG. 18 shows a cross section of a rotor blade, wherein possible positions of pre-cured elongated elements 240 are shown according to embodiments. Therein, elements are provided in a spar cap 230 as described before, and as a reinforcement to the trailing edge 370 and the leading edge 380.

FIG. 19 shows a partial cross-sectional view of a rotor blade 22, in which pre-cured elements 240 are provided in a root portion 24 according to embodiments.

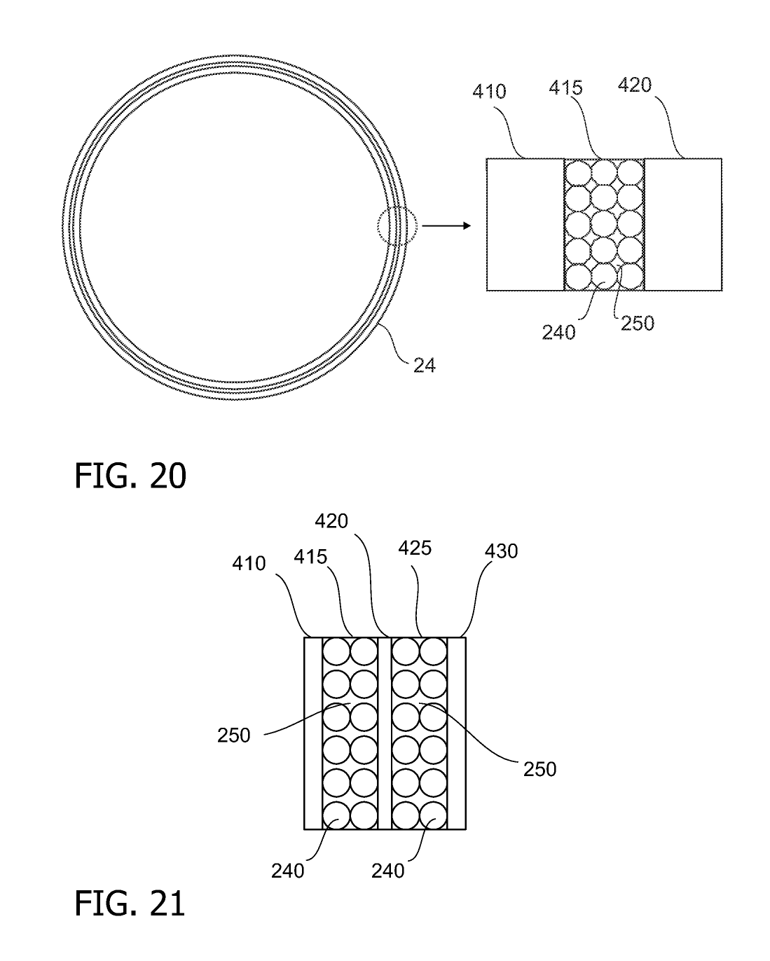

The circular root portion 24 of rotor blades may be formed from pre-produced halves, which are fabricated separately from the rest of the rotor blade body. These parts are typically produced by placing layers of fibrous material in a mold and injecting or vacuum infusing them with a resin. As shown in FIG. 20, the circular root portion 24, according to embodiments, includes layers 410, 420 of fibrous material injected with a resin 250 (not shown in detail), and at least one layer 415 of pre-cured elongated elements 240 injected with a resin 250. Typically, all layers are first placed in the mold and subsequently, the whole stack of layers 410, 420, 430 is injected or vacuum infused with resin 250. In order to further improve the stability of the root portion 24 and to ease flow of the resin through the stack, the surface of the pre-cured elements 240 may be pre-treated. This may include roughing their surface, for instance by sand-blasting, or by mechanically producing grooves in the surface, or by producing small bumps respectively protrusions on the surface, for instance by applying a plurality of droplets of resin or other materials on the surface of the elements prior to placing them in the mold.

FIG. 21 shows a partial cross sectional view similar to that of FIG. 20, wherein the root portion 24 includes a plurality of fibrous layers 410, 420, 430, which are stacked with layers 415, 425 of pre-cured elements 240. The fibrous layers may be applied in a unidirectional and biaxial orientation, wherein the greater part of the fibers is typically provided in biaxial orientation. The biaxial orientation provides for greater stability in various directions than is achieved by unidirectional layers. Further, biaxial orientation may ease the resin flow during subsequent infusion/injection.

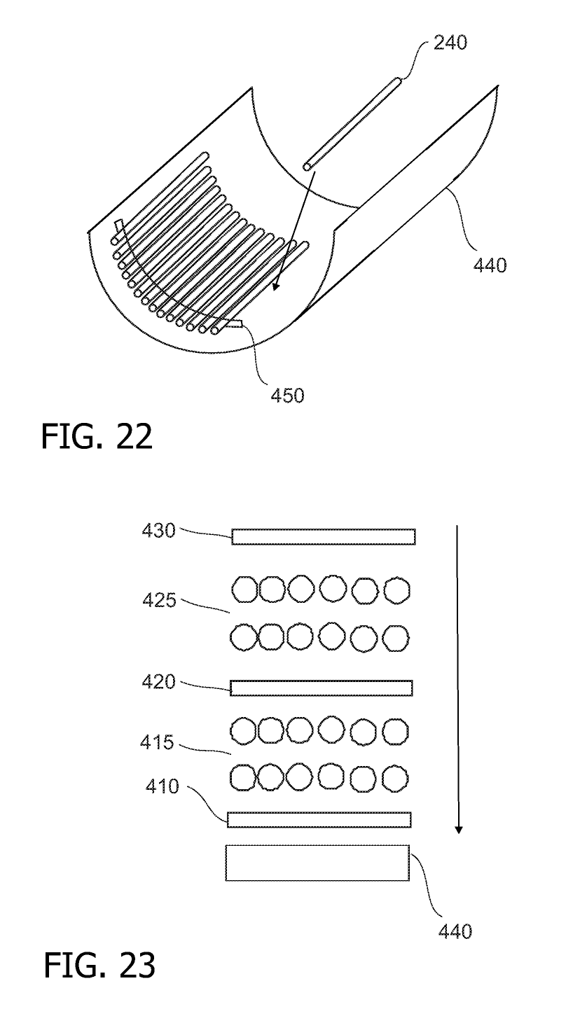

FIG. 22 shows how the pre-cured elongated elements 240 are placed into mold 440 in order to form a layer of pre-cured elements. In order to stabilize the elements in the half-circular mold prior to the injection of resin, the elements may be held by one or more auxiliary stabilization elements 450 (only schematically shown). In FIG. 22, element 450 only covers a part of the circumferential span of the mold for illustrational purposes. The pre-cured elongated elements 240 in this embodiment typically have ends which are similar shaped as the end portions 330 in FIG. 12.

FIG. 23 shows how a plurality of layers of fibrous material 410, 420, 430 are stacked (indicated by the arrow) intermittently with double layers 415, 425 of pre-cured elements 240 onto mold 440. The surfaces of elements 240 are pre-treated to have an elevated roughness as described before. After the stacking, resin 250 is vacuum-infused (not shown) into the stack of layers.

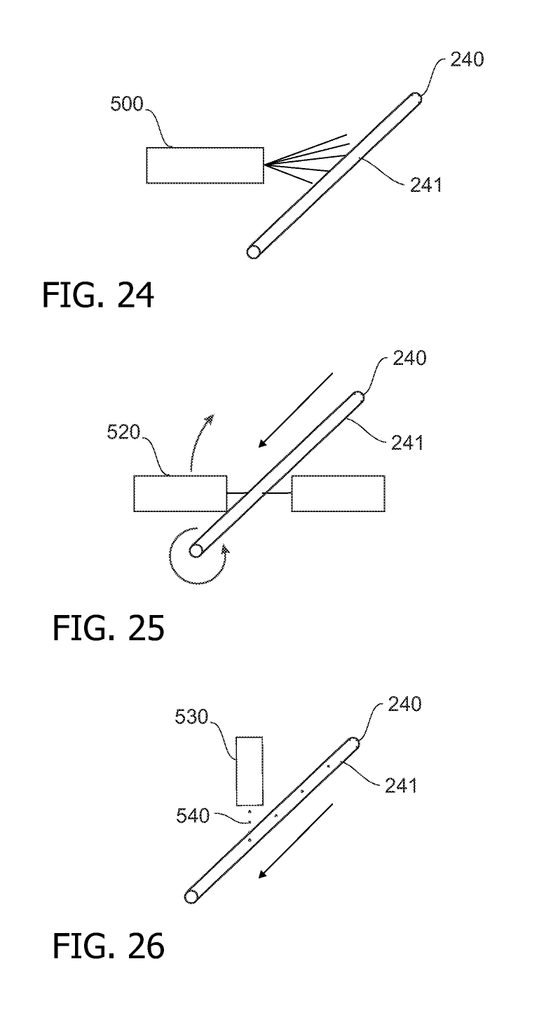

FIGS. 24 to 26 show the pre-treating of a pre-cured element 240 according to embodiments. FIG. 24 shows how the surface roughness of surface 241 of element 240 is increased or elevated by sandblasting with a sandblasting device 500.

FIG. 25 shows how at least one groove is cut into the surface 241 of element 240 by a cutting device 520. Element 240 may be turned during the process, achieving at least one spirally wound groove. Alternatively, cutting device 520 may be moved in a spiral or circular movement around the element 240, which is indicated by the arrow above device 520

FIG. 26 show how droplets 540 of a resin are applied to the surface 241 of element 240 by a device 530. The density of droplets is strongly dependent on the individual case. In embodiments, the droplet density may be 0.1 to 20 per cm², more typically 1 to 10 per cm². After curing, the droplets form small protrusions or bumps on the surface 241, elevating the effective surface roughness.

The elements 240 shown in FIGS. 24, 25, and 26 exhibit a round shape. However, they may have any cross sectional shape as described before.

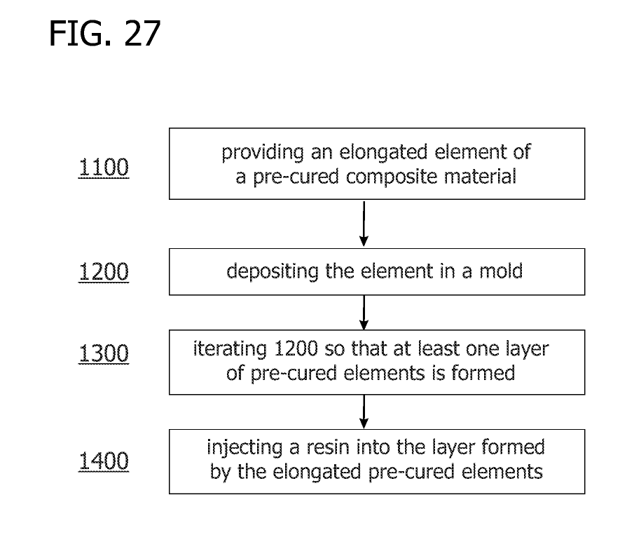

FIG. 27 shows a flow chart of a method for producing a wind turbine rotor blade according to embodiments. The method includes providing an elongated element of a pre-cured composite material in block 1100; depositing the element in a mold in block 1200; iterating block 1200 so that at least one layer of pre-cured elements is formed in block 1300; and injecting a resin into the layer formed by the elongated pre-cured elements in block 1400.

Pre-treating methods for pre-cured elongated elements as used in the production of wind turbine rotor blades are described. In various embodiments described herein, the elements exhibit a rectangular or square shape. When these elements are positioned parallel to each other when forming a layer, the side faces of parallel elements may be in tight contact with each other. Moreover, typically all layers of a spar cap are formed by positioning their respective elements, before starting to insert resin into the so formed layer in order to connect the various elements. Hence, there is a stack of elements which tightly fit together, before it is started to inject the resin in order to connect the elements. Consequently, if the elements are not treated to increase flow of resin into the stack, parts of the contact faces between elements may not be reached by resin, or it may take a long time before all faces are sufficiently covered with resin to allow for a stable bonding.

In order to ease this process, some or all faces of the elements may be pre-treated before being positioned in the spar cap mold to form a layer, or the stack of layers, respectively.

In another embodiment, small droplets of a quick-binding resin are applied to the surface of the elements before positioning them in the mold. This resin cures before the element is positioned in the mold, and the droplets thus form kind of spacers between the elements, providing enough space for the resin to flow through the stack.

The above-described systems and methods facilitate the production of wind turbine rotor blades with improved characteristics. More specifically, they facilitate the production of rotor blades having improved mechanical stability.

Exemplary embodiments of systems and methods for the production of wind turbine rotor blades are described above in detail. The systems and methods are not limited to the specific embodiments described herein, but rather, components of the systems and/or steps of the methods may be utilized independently and separately from other components and/or steps described herein. For example, the methods may be applied to other rotor blades, and are not limited to practice with only the wind turbine systems as described herein. Rather, the exemplary embodiment can be implemented and utilized in connection with many other rotor blade applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A wind turbine rotor blade, comprising:
a) a rotor blade body, including a root portion, a leading edge, a trailing edge,
and at least one spar cap;
b) a plurality of parallel, elongated elements of a pre-cured composite material, which comprise fibers and a resin; and,
c) a resin connecting the plurality of elements.

2. A wind turbine rotor blade according to claim 1, wherein the elongated elements are provided in one or more elements from the list including: a root section, a spar cap, a trailing edge, and a leading edge.

3. The rotor blade of claim 1, wherein at least one of the elongated elements has a cross-section exhibiting a shape chosen from the list consisting of: a polygon, a rectangle, a square, a circle, and an ellipse.

4. The rotor blade of claim 1, wherein the at least one spar cap comprises a plurality of layers of elements of a pre-cured composite material in a direction perpendicular to the chord line and to the longitudinal axis of the blade.

5. The rotor blade of claim 4, wherein the length of at least one element of a first layer is different to the length of at least one element of a second layer.

6. The rotor blade of claim 4, wherein the spar cap exhibits different thickness values at different portions along its length.

7. The rotor blade of claim 1, wherein the elements comprise at least one element from the list consisting of: carbon fiber, glass fiber, and combinations thereof.

8. The rotor blade of claim 1, wherein a surface of at least one of the elongated elements comprises protrusions or at least one groove.

9. The rotor blade of claim 4, wherein at least one longitudinal section of at least one element of a first layer has a cross sectional shape different from that of another longitudinal section of the at least one element.

10. The rotor blade of claim 1, wherein the pre-cured elements are provided in a root section of the blade, and wherein the longitudinal axes of the elements are substantially parallel to a longitudinal axis of the rotor blade.

11. The rotor blade of claim 10, wherein the root portion of the rotor blade comprises at least one layer of a fibrous material and a resin, and at least one layer formed of elongated pre-cured elements and a resin, and wherein the at least one layer of a fibrous material comprises fibrous material provided unidirectionally or biaxially.

12. A wind turbine, comprising:
a) a tower;
b) a nacelle situated on the tower; and,
c) a rotor rotatably attached to the nacelle, having at least one rotor blade, wherein the at least one rotor blade includes
i) a rotor blade body, including a root portion, a leading edge, a trailing edge, and at least one spar cap;
ii) a plurality of parallel, elongated elements of a pre-cured composite material, which comprise fibers and a resin; and,
iii) a resin connecting the plurality of elements.

13. A method for producing a wind turbine rotor blade, comprising:
a) providing an elongated element of a pre-cured composite material;
b) depositing the element in a mold;
c) iterating b) so that at least one layer of pre-cured elements is formed; and
d) injecting a resin into the layer formed by the elongated pre-cured elements.

14. The method of claim 13, wherein the pre-cured elements are deposited in the mold for a spar cap, or for a blade root portion.

15. The method of claim 14, wherein in a mold for a spar cap, in a direction perpendicular to the chord of the blade and to the longitudinal axis of the blade, at least two layers of pre-cured elements are formed.

16. The method of claim 13, wherein the composite material comprises at least one element of the list consisting of: carbon fiber, glass fiber, and combinations thereof.

17. The method of claim 13, wherein the pre-cured composite material is provided on spools.

18. The method of claim 13, wherein the composite material is pre-treated prior to depositing it in the mold.

19. The method of claim 18, wherein pre-treating comprises at least one of the following: sputtering droplets of resin on a surface of the material, sand-blasting the material, treating the surface with a tool, producing grooves or dimples in the surface.

20. The method of claim 13, further comprising providing at least one layer of a fibrous material on the at least one layer of pre-cured elements, wherein the layer of a fibrous material is provided unidirectionally or biaxially, and wherein a resin is injected into a stack formed by the at least one layer of a fibrous material and the at least one layer of pre-cured elements.
